(19) United States
(12) Patent Application Publication
(10) Pub. No.: US 2025/0211076 A1
(43) Pub. Date: Jun. 26, 2025

(54) MANUFACTURING METHOD OF ROTARY ELECTRIC MACHINE COIL

(71) Applicant: HONDA MOTOR CO., LTD., Tokyo (JP)

(72) Inventors: Kentaro Fukui, Tokyo (JP); Shuhei Okuda, Tokyo (JP)

(21) Appl. No.: 18/916,765

(22) Filed: Oct. 16, 2024

(30) Foreign Application Priority Data
Dec. 21, 2023 (JP) 2023-216237

(51) Int. Cl. H02K 15/04; B21F 3/02

(52) U.S. Cl. CPC H02K 15/0407; B21F 3/02

(57) ABSTRACT

A rotary electric machine coil has a first side surface and a second side surface that face in an opposite direction to each other, and a recess groove along a longitudinal direction is provided on each of the first side surface and the second side surface. In the manufacturing of the rotary electric machine coil, when the recess groove is being formed by a press molding on one of the first side surface and the second side surface, a press molding of the recess groove to another of the first side surface and the second side surface is started.

### CROSS-REFERENCE TO RELATED APPLICATION

Priority is claimed on Japanese Patent Application No. 2023-216237, filed on Dec. 21, 2023, the contents of which are incorporated herein by reference.

### BACKGROUND

### Field of the Invention

The present invention relates to a manufacturing method of a rotary electric machine coil.

### Background

As a rotary electric machine such as an electric motor or an electricity generator, a rotary electric machine is known in which a rotor is arranged to be rotatable on an inside in a radial direction of a stator having an annular shape. The stator includes a stator core and a coil (rotary electric machine coil) that is wound around the stator core. In the stator core, for example, a back yoke having a cylindrical shape and a plurality of teeth portions that protrude inward in the radial direction from the back yoke are integrally formed. A slot is formed between the teeth portions that are adjacent to each other in a circumferential direction. The coil is wound around each teeth portion through the slot that is arranged on both sides of the teeth portion.

In this type of rotary electric machine, since the coil is at a high temperature at the time of use, it is desirable to efficiently cool the coil. As a method for efficiently cooling the coil of the rotary electric machine, a method is known in which a cooling liquid is caused to flow around the coil (for example, refer to Japanese Patent No. 7139969).

In the rotary electric machine described in Japanese Patent No. 7139969, the coil (rotary electric machine coil) that is wound around the teeth portion of the stator core is formed of a rectangular wire. Then, a recess groove having a substantially arc shape is formed on a side surface (side surface that faces in a direction that crosses an extension direction) of an insertion portion of the coil that is inserted through a slot. The cooling liquid that is introduced from one end side in an axis direction of the stator core flows into the recess groove, and the cooling liquid flows out to another end side in the axis direction. At this time, the coil is efficiently cooled by the cooling liquid that flows through the recess groove.

### SUMMARY

When the recess groove as described above is formed on both side surfaces that face in an opposite direction of the coil, the coil is placed on a placement base such that one side surface faces upward, a male mold for forming a groove is lowered in that state, and the recess groove is formed by press molding on the one side surface of the coil. Then, after the press molding of the recess groove to the one side surface is completed, another side surface of the coil is caused to face upward by inverting the coil, and the recess groove is formed by press molding to the other side surface using the male mold similarly to the one side surface.

When the recess groove is formed on the two side surfaces that face in the opposite direction of the coil in this way, a compressive load acts between a flat upper surface of the placement base and a press portion having a mountain shape of the male mold that is pressed to an upper surface at a substantially middle in a width direction of the coil when the male mold is pressed to the one side surface (a surface that faces upward). At this time, since the other side surface (a surface that faces downward) of the coil comes into contact with the upper surface of the placement base in a wide region in the width direction, a large stress acts on a cross section of the coil between a substantially middle region in the width direction of the upper surface to which the male mold is pressed and a wide region in the width direction which the upper surface of the placement base comes into contact. That is, a portion on which a large stress acts spreads in a divergent manner toward a lower side of the coil cross section or is distributed to be bifurcated into two parts in the width direction.

Then, when the other side surface of the coil is caused to face upward by inverting the coil, and the male mold is pressed to the other surface, a compressive load acts similarly between the upper surface of the placement base and the press portion of the male mold at an upper side.

At this time, a portion where a large stress acts between the substantially middle region in the width direction of the upper surface to which the male mold is pressed and the wide region in the width direction which the upper surface of the placement base comes into contact distributes in the cross section of the coil, but part of the stress generated when the recess groove is formed on the one side surface remains in the cross section of the coil. Therefore, in the cross section of the coil in which the molding is completed, the stress generated when the recess groove is formed on the one side surface and the stress generated when the recess groove is formed on the other side surface are combined and remain in a wide range. Accordingly, when the recess groove is formed on the two side surfaces that face in the opposite direction of the coil by the method described above, a large strain is likely to occur in the coil.

The present invention aims at providing a manufacturing method of a rotary electric machine coil in which an unnecessary strain is less likely to occur when a recess groove is formed on side surfaces that face in an opposite direction.

A rotary electric machine coil manufacturing method according to an aspect of the present invention is a manufacturing method of a rotary electric machine coil which has a first side surface and a second side surface that face in an opposite direction to each other and in which a recess groove along a longitudinal direction is provided on each of the first side surface and the second side surface, the rotary electric machine coil manufacturing method including: when the recess groove is being formed by a press molding on one of the first side surface and the second side surface, starting a press molding of the recess groove to another of the first side surface and the second side surface.

In the rotary electric machine coil manufacturing method according to the aspect of the present invention, the press molding for forming the recess groove on the first side surface and the press molding for forming the recess groove on the second side surface are performed in a temporally overlapping manner. At this time, a direction of a load applied to the first side surface for forming the recess groove on the first side surface and a direction of a load applied to the second side surface for forming the recess groove on the second side surface face each other. Therefore, a part having a high stress concentrates on a region in the coil that linearly connects a press portion for forming the recess groove on the first side surface to a press portion for forming the recess groove on the second side surface, and the part having a high stress is less likely to spread to other parts. Accordingly, after the processing of the recess groove is completed, a strain is less likely to occur in an unnecessary part in a cross section of the coil.

Further, when the present method is employed, since the stress is less likely to occur in an unnecessary part in the cross section of the coil during processing, it is possible to reduce a load required for processing, and it is possible to realize smooth processing of the rotary electric machine coil.

At least one of start timings of the press molding to the first side surface and the second side surface and end timings of the press molding to the first side surface and the second side surface may be matched with each other.

In this case, when the start timings of the press molding to the first side surface and the second side surface are matched with each other, a deformation load that rapidly increases at an initial stage of the pressing is concentrated between the press portions of both side surfaces, and it is possible to prevent a part having a high stress from diffusing to the periphery. Further, when the end timings of the press molding to the first side surface and the second side surface are matched with each other, even if there is some variation in deformation in the first side surface and the second side surface prior to the end of the press molding, it is possible to finally correct the variation in the deformation.

Each of the start timings of the press molding to the first side surface and the second side surface and the end timings of the press molding to the first side surface and the second side surface may be matched with each other.

In this case, the deformation load that rapidly increases at the initial stage of the pressing can be concentrated between the press portions of the first and second side surfaces, and it is possible to finally correct the variation in the deformation of the first side surface and the second side surface.

When the press molding is performed to the first side surface and the second side surface, a pair of other side surfaces that face in an opposite direction other than the first side surface and the second side surface may be sandwiched by a support mold.

In this case, by sandwiching the pair of other side surfaces by the support mold, it is possible to prevent the rotary electric machine coil from rotating at the time of the press molding. Accordingly, it is possible to perform the press molding to the rotary electric machine coil with high accuracy.

The support mold may be biased by a spring to be displaceable when a load is input.

In this case, since the support mold that sandwiches the rotary electric machine coil is biased to be displaceable by the spring, it is possible to absorb an impact associated with an input of a large load at the time of the press molding by the function of the spring. Accordingly, when the present method is employed, the processing of the coil can be stably performed while eliminating falling off or displacement of the coil from a process device.

In the rotary electric machine coil manufacturing method according to the aspect of the present invention, when the recess groove is being formed by the press molding on one of the first side surface and the second side surface, the press molding of the recess groove to another of the first side surface and the second side surface is started, and therefore, the press molding of the first side surface and the press molding of the second side surface can be performed in a temporally overlapping manner. The press molding of the first side surface and the press molding of the second side surface can be performed from directions that face to each other. Accordingly, when the rotary electric machine coil manufacturing method according to the aspect of the present invention is employed, an unnecessary strain is less likely to occur in the coil when the recess groove is formed on the side surfaces that face in the opposite direction. Therefore, it is possible to further enhance a product quality of the rotary electric machine coil.

### BRIEF DESCRIPTION OF THE DRAWINGS

FIG. 1 is a longitudinal cross-sectional view of a rotary electric machine of an embodiment.

FIG. 2 is a cross-sectional view along a II-II line of FIG. 1 of the rotary electric machine of the embodiment.

FIG. 3 is a perspective view of a process device of a rotary electric machine coil of the embodiment.

FIG. 4 is a schematic cross-sectional view of the process device of the rotary electric machine coil of the embodiment.

FIG. 5 is a view showing process steps (A), (B), (C), (D) of a comparison example and a pressure distribution of a coil inner portion at that time.

FIG. 6 is a view showing process steps (A), (B) of the embodiment and a pressure distribution of a coil inner portion at that time.

### DESCRIPTION OF EMBODIMENTS

Hereinafter, an embodiment of the present invention will be described with reference to the drawings.

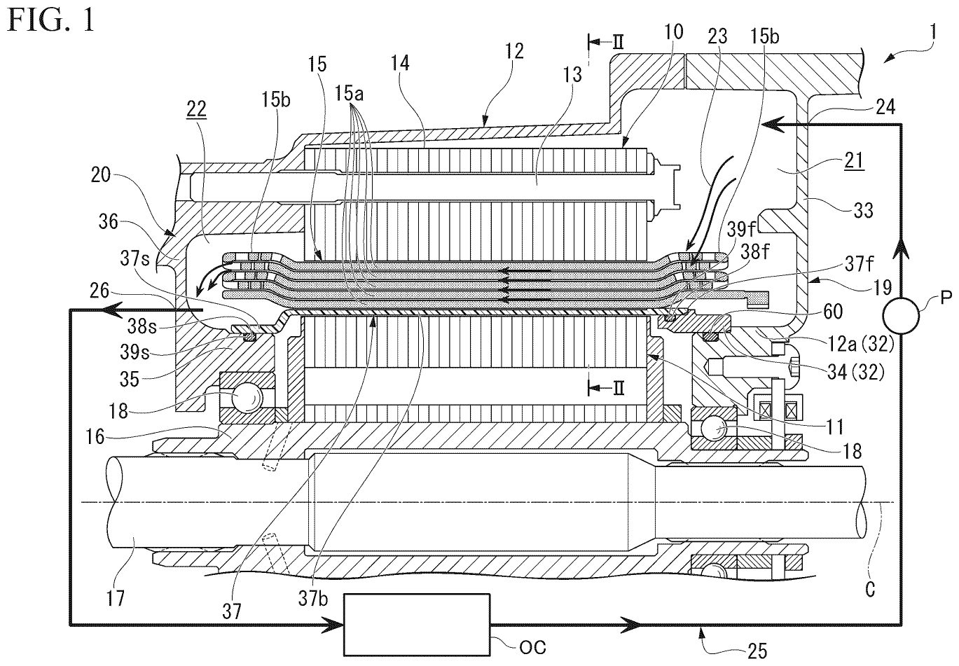

FIG. 1 is a longitudinal cross-sectional view of a rotary electric machine 1 of the present embodiment.

The rotary electric machine 1 of the present embodiment includes a stator 10 and a rotor 11. The stator 10 and the rotor 11 are accommodated in a rotary electric machine case 12. The stator 10 is fixed to an inside of the rotary electric machine case 12 by the fastening using a bolt 13 or the like. The stator 10 includes a stator core 14 having a cylindrical shape and a plurality of coils 15 that are wound around the stator core 14. The rotor 11 is rotatably arranged at an inside in a radial direction of the stator core 14 (stator 10).

The coil 15 constitutes a rotary electric machine coil in the present embodiment.

A permanent magnet (not shown) is attached to the vicinity of an outer circumferential surface of the rotor 11. Further, the rotor 11 is rotatably supported integrally by a rotation shaft 17 via a sleeve 16. The rotation shaft 17 becomes an output shaft when the rotary electric machine 1 is used as a motor, and the rotation shaft 17 becomes a power input shaft when the rotary electric machine 1 is used as an electricity generator. The rotation shaft 17 and the sleeve 16 are rotatably supported by the rotary electric machine case 12 via a bearing 18.

In the following description, a direction parallel to a rotation axis line C of the rotor 11 is referred to as an axis direction, a rotation direction of the rotor 11 is referred to as a circumferential direction, and a radial direction of the rotor 11 that is orthogonal to the axis direction and the circumferential direction is referred to as a radial direction.

A first side case 19 and a second side case 20 that have an annular shape are arranged on one end side and another end side in the axis direction of the stator core 14. Main parts of the first side case 19 and the second side case 20 are formed of the rotary electric machine case 12.

The first side case 19 covers, from the outside, one end surface in the axis direction of the stator core 14 and an exposure portion of the coil 15 that protrudes from the end surface. The first side case 19 forms a first liquid room 21 having an annular shape together with the one end surface in the axis direction of the stator core 14. An introduction port 24 for introducing a cooling liquid 23 into the first liquid room 21 is formed on the first side case 19. The introduction port 24 is connected to a circulation circuit 25 of the cooling liquid 23. The cooling liquid 23 that is introduced into the first liquid room 21 cools the exposure portion of the coil 15 that protrudes from the one end surface of the stator core 14, then passes through the inside of the stator core 14, and flows into another end side in the axis direction of the stator core 14.

The second side case 20 covers, from the outside, another end surface in the axis direction of the stator core 14 and an exposure portion of the coil 15 that protrudes from the end surface. The second side case 20 forms a second liquid room 22 having an annular shape together with the other end surface in the axis direction of the stator core 14. The cooling liquid 23 that is introduced into the first liquid room 21 flows into the second liquid room 22 through the inside of the stator core 14. The cooling liquid 23 that is introduced into the second liquid room 22 cools the exposure portion of the coil 15 that protrudes from the other end surface of the stator core 14. A discharge port 26 for discharging the cooling liquid 23 in the second liquid room 22 to the outside is formed on the second side case 20. The discharge port 26 is connected to the circulation circuit 25 of the cooling liquid 23. The cooling liquid 23 that has cooled the coil 15 in the second liquid room 22 is caused to return to the circulation circuit 25 from the discharge port 26.

In the circulation circuit 25, a supply pump P is connected to a middle of the circuit. A heat exchanger OC that cools the cooling liquid 23 by a heat exchange with outside air is connected to an upstream side of the supply pump P in the circulation circuit 25. A downstream side of the supply pump P is connected to the introduction port 24. Further, an upstream side of the heat exchanger OC in the circulation circuit 25 is connected to the discharge port 26.

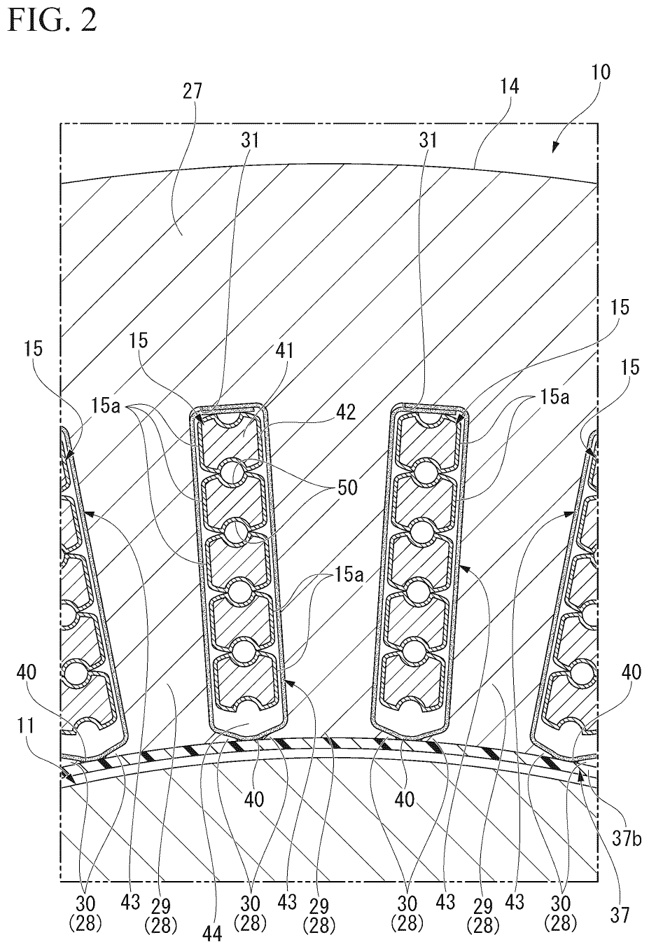

FIG. 2 is a cross-sectional view along a II-II line of FIG. 1 of the rotary electric machine 1.

The stator core 14 is formed, for example, by laminating a plurality of electromagnetic steel plates in the axis direction. In the stator core 14, as shown in FIG. 2, a back yoke 27 having a cylindrical shape and a plurality of teeth portions 28 that protrude inward in the radial direction from an inner circumferential portion of the back yoke 27 are integrally molded. The back yoke 27 is formed such that a cylinder center is matched with the rotation axis line C.

The teeth portions 28 are arranged to be spaced apart from each other in the circumferential direction. The teeth portion 28 is formed in a T shape when seen from the axis direction. That is, in the teeth portion 28, a teeth main body 29 that protrudes inward in the radial direction from the inner circumferential portion of the back yoke 27 and a flange portion 30 that projects to both sides in the circumferential direction from an inner end in the radial direction in the teeth main body 29 are integrally molded.

A slot 31 in which an inner side in the radial direction is opened is formed between the teeth portions 28 that are adjacent to each other in the circumferential direction. The slot 31 is formed to be surrounded by side walls that face each other of the teeth portions 28 that are adjacent to each other and an inner circumferential wall of the back yoke 27. The side wall of each teeth portion 28 is formed of a side portion of the teeth main body 29 and a side section of the flange portion 30. A portion of the slot 31 that is formed of the side portions of the right and left teeth main bodies 29 has a substantially constant width. Further, the width of a portion of the slot 31 that is formed of the side sections of the right and left flange portions 30 is narrower than the width of the portion that is formed of the side portions of the right and left teeth main bodies 29.

An opening 40 on the inside in the radial direction of each slot 31 is formed to be sandwiched by front end sections of the right and left (both sides in the circumferential direction) flange portions 30 of the slot 31. Further, each slot 31 penetrates through the stator core 14 in the axis direction.

In the coil 15, for example, three phases which are a U-phase, a V-phase, and a W-phase are provided. The coil 15 is constituted, for example, by connecting a plurality of segment coils to each other. In the coil 15, an outer surface of a conductor wire 41 made of a metal is covered by an insulation film 42. Further, the coil 15 is constituted of a rectangular wire. That is, the shape of a cross section that is orthogonal to an extension direction of the coil 15 is formed in a substantially rectangular shape.

Each coil 15 is inserted along the axis direction through the slot 31 of the stator core 14 and is wound around a corresponding teeth portion 28 in that state.

Hereinafter, a portion of the coil 15 that is inserted through the slot 31 is referred to as an “insertion portion 15a”, and a portion that is exposed to the outside of the slot 31 and is drawn in a direction of another slot 31 is referred to as a “drawn portion 15b”.

As shown in FIG. 2, a plurality of insertion portions 15a of the coil 15 are inserted through each slot 31 in a step manner. The plurality of insertion portions 15a that are inserted through the same slot 31 are aligned in a line along the radial direction. In the present embodiment, for example, five insertion portions 15a are inserted through the same slot 31. However, the number of the insertion portions 15a that are inserted through the same slot 31 is not limited to this and can be arbitrarily set.

In a state where the plurality of insertion portions 15a that are inserted and arranged in each slot 31 are bundled so as to be aligned in a line in parallel with each other, and the periphery of the plurality of insertion portions 15a is covered by a sheet of a foamable insulation member 43. For example, it is possible to employ a foamable insulation member 43 in which a foamable adhesion bond is arranged (applied) on a surface (a surface that faces outward in a state of covering the insertion portion 15a) of a base material sheet having an electrical insulation property, and a non-foamable adhesion bond is arranged (applied) on a rear surface of the base material sheet. The foamable insulation member 43 is inserted and arranged in a corresponding slot 31 together with the plurality of insertion portions 15a in a state of covering the periphery of the plurality of insertion portions 15a. Then, by performing a heating treatment or the like, the foamable insulation member 43 foams in the corresponding slot 31. As a result, part of the outer surface of the foamable insulation member 43 is bonded to the inner wall of the slot 31.

Even after the insertion portion 15a of the coil 15 and the foamable insulation member 43 are arranged in the slot 31 as described above, a gap for causing one end side and another end side in the axis direction of the stator core 14 to communicate with each other is ensured at the inside of the slot 31. The gap constitutes a cooling liquid passage 44 for causing the cooling liquid that is introduced into the first liquid room 21 to flow to the second liquid room 22 side. The gap that constitutes the cooling liquid passage 44 is, specifically, a gap between an inner surface of the foamable insulation member 43 and the insertion portion 15a, a gap between the insertion portions 15a that are adjacent to each other, a gap between an outer surface of the foamable insulation member 43 and an inner wall of the slot 31, or the like. The cooling liquid 23 that flows through the cooling liquid passage 44 in the slot 31 absorbs heat of the insertion portion 15a of the coil 15.

A recess groove 50 that extends along the axis direction of the stator core 14 is formed on a side surface that faces outward in the radial direction and a side surface that faces inward in the radial direction of each insertion portion 15a which is arranged in the slot 31. The recess groove 50 is formed to be recessed in a substantially arc shape toward a middle region in a width direction of the insertion portion 15a.

When the plurality of insertion portions 15a are arranged together with the foamable insulation member 43 in the slot 31, the recess groove 50 forms a gap (communication gap) that extends substantially along the axis direction between side surfaces that face each other of the insertion portions 15a which are adjacent to each other in the radial direction and between a side surface of the insertion portion 15a and an inner surface of the foamable insulation member 43.

In the present embodiment, the recess groove 50 that is formed on the side surface of the coil 15 constitutes a cooling liquid flow groove. Further, in the present embodiment, the recess groove 50 is formed so as to continue to the recess groove 50 of the insertion portion 15a also on the drawn portion 15b of the coil 15.

Further, as shown in FIG. 1, the first side case 19 on one end side in the axis direction of the stator core 14 includes a first inner circumferential wall 32 that faces the first liquid room 21. The first inner circumferential wall 32 protrudes in a cylindrical shape from an inner end portion in the radial direction of an end side wall 33 of the first side case 19 located at an outer end in the axis direction of the first liquid room 21 toward one end surface in the axis direction of the rotor 11. In the case of the present embodiment, the first inner circumferential wall 32 is constituted of a circumferential wall main body portion 12a that is formed integrally with the rotary electric machine case 12 (end side wall 33) and a cylindrical member 34 as a separate body that is attached to an outer circumferential surface on an extension end side of the circumferential wall main body portion 12a. A space between the circumferential wall main body portion 12a and the cylindrical member 34 is sealed by a seal member 60 having an annular shape.

However, the entire first inner circumferential wall 32 may be formed integrally with the rotary electric machine case 12 (end side wall 33).

Further, the second side case 20 on another end side in the axis direction of the stator core 14 includes a second inner circumferential wall 35 that faces the second liquid room 22. The second inner circumferential wall 35 protrudes in a cylindrical shape from an inner end portion in the radial direction of an end side wall 36 of the second side case 20 located at an outer end in the axis direction of the second liquid room 22 toward another end surface in the axis direction of the rotor 11. In the case of the present embodiment, the second inner circumferential wall 35 is formed integrally with the rotary electric machine case 12 (end side wall 36).

However, the second inner circumferential wall 35 may be constituted of a circumferential wall main body portion that is integral with the rotary electric machine case 12 (end side wall 36) similarly to the first inner circumferential wall 32 and a cylindrical member as a separate body.

An annular partition wall 37 which is a cover member having a cylindrical shape is provided on an outer circumferential surface of the first inner circumferential wall 32 of the first side case 19 and an outer circumferential surface of the second inner circumferential wall 35 of the second side case 20. The annular partition wall 37 is formed of, for example, a resin material. However, the annular partition wall 37 can be also formed of another material such as a metal material. The annular partition wall 37 has a first end portion 37f that faces the inside of the first liquid room 21, a second end portion 37s that faces the inside of the second liquid room 22, and a partition wall main body portion 37b that is located between the first end portion 37f and the second end portion 37s and faces an inner circumferential surface of the stator core 14. The first end portion 37f is formed to have the same inner diameter as the partition wall main body portion 37b. The diameter of a middle portion in an extension direction of the second end portion 37s is reduced in a step manner with respect to the partition wall main body portion 37b.

An inner circumferential surface of the first end portion 37f is slidably fitted to an outer circumferential surface of the cylindrical member 34 of the first inner circumferential wall 32. An annular groove 38f is formed on the outer circumferential surface of the cylindrical member 34, and a seal member 39f having an annular shape such as an O-ring is attached to the annular groove 38f. A space between the cylindrical member 34 (first inner circumferential wall 32) and the first end portion 37f (annular partition wall 37) is sealed in a liquid-tight manner by the seal member 39f.

In the present embodiment, the first end portion 37f constitutes, at the inside of the first liquid room 21, a guide member that guides the cooling liquid in the first liquid room 21 to the slot 31 on one end side in the axis direction of the stator core 14.

An inner circumferential surface of a reduced diameter section of the second end portion 37s is slidably fitted to an outer circumferential surface of the second inner circumferential wall 35. An annular groove 38s is formed on the outer circumferential surface of the second inner circumferential wall 35, and a seal member 39s having an annular shape such as an O-ring is attached to the annular groove 38s. A space between the second inner circumferential wall 35 and the second end portion 37s (annular partition wall 37) is sealed in a liquid-tight manner by the seal member 39f.

In the annular partition wall 37, as described above, the first end portion 37f is fitted in a liquid-tight manner to the first inner circumferential wall 32 of the first side case 19, and the second end portion 37s is fitted in a liquid-tight manner to the second inner circumferential wall 35 of the second side case 20. The annular partition wall 37 separates an inner region in the radial direction of the stator core 14 attached to the inside of the rotary electric machine case 12 from the outer circumferential surface of the rotor 11. Therefore, even if the cooling liquid 23 leaks out from the slot 31 of the stator core 14 to the inner region in the radial direction, it is possible to prevent the cooling liquid 23 from flowing into the outer circumferential surface side of the rotor 11.

Further, an expansion portion that expands further outward in the radial direction than an outer circumferential surface of the partition wall main body portion 37b is provided on an outer circumferential surface of the first end portion 37f of the annular partition wall 37. An end section of the expansion portion on the stator core 14 side stands outward in the radial direction in a step manner with respect to the outer circumferential surface of the partition wall main body portion 37b. This standing end surface is in contact with an end surface on the one end side in the axis direction of the stator core 14.

As shown in FIG. 2, the outer circumferential surface of the partition wall main body portion 37b of the annular partition wall 37 is maintained in a state of being in contact with the inner circumferential surface of the stator core 14. Further, the inner circumferential surface of the partition wall main body portion 37b of the annular partition wall 37 faces the outer circumferential surface of the rotor 11 with a small gap so as to be non-contact with the outer circumferential surface of the rotor 11.

The foamable adhesion bond on the outer surface side foams by heating or the like, and thereby, the foamable insulation member 43 that is accommodated and arranged in each slot 31 of the stator core 14 together with the plurality of insertion portions 15a of the coil 15 enters the inside of the opening 40 at the inside in the radial direction of the slot 31. The foamable adhesion bond that has entered the inside of the opening 40 is bonded to an outer circumferential surface of the annular partition wall 37 that is arranged at the outside (inside in the radial direction) of the opening 40. As a result, the circumferential wall main body portion 12a of the annular partition wall 37 is bonded and fixed to the foamable insulation member 43 at the inside of the plurality of slots 31 through the opening 40 of the slot 31.

In the rotary electric machine 1 having the configuration described above, when a current continuously flows through the coil 15 at the time of operation, the coil 15 generates heat and becomes a high temperature.

At this time, the cooling liquid 23 is introduced into the first liquid room 21 of the rotary electric machine 1 through the introduction port 24 from the circulation circuit 25. The cooling liquid 23 that is introduced into the first liquid room 21 flows in the first liquid room 21 and thereby cools a region (the drawn portion 15b) on one end portion side of the coil 15 that is exposed to the outside from the one end side in the axis direction of the stator core 14. Further, the cooling liquid 23 flows through the plurality of slots 31 (cooling liquid passage 44 in the slots 31) of the stator core 14 from one end side toward another end side in the axis direction and flows into the second liquid room 22. The cooling liquid that flows through the inside of the slot 31 cools the insertion portion 15a of the coil 15 that is inserted through the inside of the slot 31. Further, the cooling liquid 23 that flows into the second liquid room 22 cools a region on another end portion side of the coil 15 that is exposed to the outside from the other end side in the axis direction of the stator core 14 and is then caused to return to the circulation circuit 25 through the discharge port 26.

In the rotary electric machine 1, the stator 10 is constantly submerged in the cooling liquid 23 in the rotary electric machine case 12 as described above, and in that state, the cooling liquid 23 in the rotary electric machine case 12 is replaced through the circulation circuit 25. Therefore, the coil 15 of the stator 10 is efficiently cooled by the cooling liquid 23.

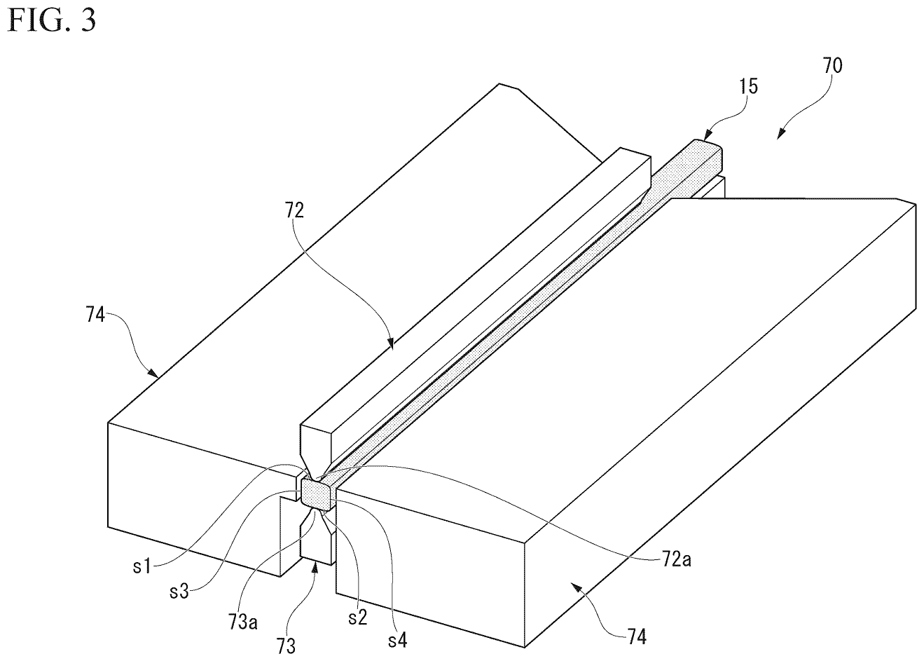

Next, a manufacturing method of the coil 15 that is wound around the stator core 14 as described above is described with reference to FIG. 3 to FIG. 6. In FIG. 3 to FIG. 6, the insulation film 42 of the coil 15 shown in FIG. 2 is omitted for ease of comprehension. Further, in the following description, a “width direction” of the coil 15 means a direction that is orthogonal to a vertical direction in a cross section (cross section in a direction that is orthogonal to the extension direction) of the coil 15.

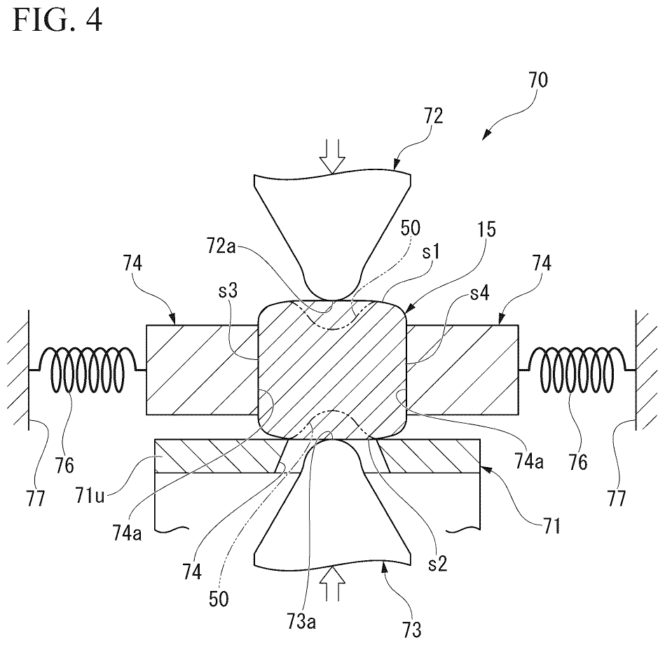

FIG. 3 is a perspective view of a process device 70 for molding the recess groove 50 on side surfaces s1, s2 of the coil 15, and FIG. 4 is a schematic cross-sectional view of the process device 70.

The coil 15 has four side surfaces s1, s2, s3, s4 that are orthogonal to the extension direction (longitudinal direction). The two side surfaces s1, s2 are arranged to face in an opposite direction to each other, and the remaining two side surfaces s3, s4 are arranged to face a direction that is orthogonal to the side surfaces s1, s2 and face in an opposite direction to each other. The recess groove 50 is formed on each of the side surfaces s1, s2 that face in the opposite direction to each other. In the present embodiment, the side surface s1 constitutes a first side surface, and the side surface s2 constitutes a second side surface. Further, the side surfaces s3, s4 constitute a pair of other side surfaces that face in the opposite direction other than the first side surface and the second side surface.

As a previous step before molding the recess groove 50 on the side surfaces s1, s2, an outer surface of the conductor wire 41 (refer to FIG. 2) having a cross section formed in a substantially rectangular shape is covered by the insulation film 42 (refer to FIG. 2), and the coil 15 is cut in advance to a predetermined length to be used. The cut coil 15 is set to the process device 70 shown in FIG. 3 and FIG. 4.

The process device 70 includes a placement base 71 (refer to FIG. 4) on which the coil 15 is placed such that the side surface s2 faces downward, a first male mold 72 for forming the recess groove 50 by press molding on the side surface s1 on the upper side of the coil 15, a second male mold 73 for forming the recess groove 50 by press molding on the side surface s2 of the lower side of the coil 15, and a pair of support molds 74 for sandwiching the right and left side surfaces s3, s4 of the coil 15.

As shown in FIG. 4, an escape hole 75 that extends along the extension direction of the coil 15 is formed on the placement base 71. The escape hole 75 is a hole for avoiding the interference with the second male mold 73 and penetrates through an upper wall 71u of the placement base 71 in an upward-downward direction.

A base portion on an upper side of the first male mold 72 is connected to a lowering operation portion of a press device (not shown).

A press portion 72a having a mountain shape in a cross section is formed on a lower end portion of the first male mold 72. A middle section in the width direction of the press portion 72a expands downward in an arc shape, and by pressing the expanding section to the side surface s1 on an upper side of the coil 15, the recess groove 50 can be formed on a middle portion in the width direction of the side surface s1.

A base portion on a lower side of the second male mold 73 is connected to a rising operation portion of the press device (not shown).

A press portion 73a having a mountain shape in a cross section is formed on an upper end portion of the second male mold 73. A middle section in the width direction of the press portion 73a expands upward in an arc shape, and by pressing the expanding section to the side surface s2 on a lower side of the coil 15, the recess groove 50 can be formed on a middle portion in the width direction of the side surface s2. Each of the right and left support molds 74 is supported by a sandwiching block 77 via a spring member 76 (refer to FIG. 4). A portion of the support mold 74 that faces the right and left side surfaces s3, s4 of the coil 15 is a support surface 74a for holding the coil 15. The coil 15 that is placed on the upper wall 71u of the placement base 71 is sandwiched and fixed by the right and left support molds 74 that are biased by the spring member 76.

Since each support mold 74 is biased by the spring member 76, when a large load (impact) is input to the coil 15 that is sandwiched by the right and left support molds 74 from the outside at the time of processing, displacement in accordance with the load is allowed. Each support mold 74 is biased by the spring member 76 so as to be displaceable when a load is input.

When the recess groove 50 is formed on the side surfaces s1, s2 of the coil 15 by using the process device 70, the coil 15 is placed on the upper wall 71u of the placement base 71, and in that state, the support surfaces 74a of the right and left support molds 74 are pressed to the side surfaces s3, s4 of the coil 15. Thereby, the coil 15 is sandwiched and fixed in a state of being biased by the spring by the right and left support molds 74.

When the coil 15 is set to the process device 70 in this way, the first male mold 72 of the process device 70 is lowered to press the press portion 72a of the first male mold 72 to the side surface s1 on the upper side of the coil 15, and second male mold 73 is raised to press the press portion 73a of the second male mold 73 to the side surface s2 on the lower side of the coil 15. Start timings of the pressing to the side surfaces s1, s2 of the coil 15 by the first male mold 72 and the second male mold 73 at this time may be the same time, or the start of the pressing by the second male mold 73 may be slightly later than the start of the pressing by the first male mold 72.

That is, in the manufacturing of the coil 15 by the process device 70, when the recess groove 50 is formed by press molding on the side surface s1 (one of the first side surface and the second side surface) on the upper side of the coil 15, the press molding of the recess groove 50 to the side surface s2 (another of the first side surface and the second side surface) on the lower side of the coil 15 is started.

In this way, when the side surface s1 on the upper side and the side surface s2 on the lower side of the coil 15 are pressed by the first male mold 72 and the second male mold 73, a compressive load acts on a region in the cross section of that coil 15 that is sandwiched between the press portion 72a of the first male mold 72 and the press portion 73a of the second male mold 73. Thereby, the region that is sandwiched between the press portion 72a of the first male mold 72 and the press portion 73a of the second male mold 73 is compressed and deformed, and the recess groove 50 is formed on each of the side surface s1 on the upper side and the side surface s2 on the lower side of the coil 15. Then, by raising the first male mold 72 and lowering the second male mold 73, the pressing to the side surfaces s1, s2 of the coil 15 is ended. End timings of the pressing to the side surfaces s1, s2 of the coil 15 by the first male mold 72 and the second male mold 73 at this time may be the same time, or the end (raising of the first male mold 72) of the pressing by the first male mold 72 may be slightly later than the end (lowering of the second male mold 73) of the pressing by the second male mold 73.

As described above, in the manufacturing method of the coil 15 of the present embodiment, when the recess groove 50 is formed by the press molding on the side surface s1 (one of the first side surface and the second side surface) on the upper side of the coil 15, the press molding of the recess groove 50 to the side surface s2 (another of the first side surface and the second side surface) on the lower side of the coil 15 is started. Therefore, the press molding for forming the recess groove 50 on one side surface s1 and the press molding for forming the recess groove 50 on another side surface s2 are performed in a temporally overlapping manner. Further, at this time, a direction of a load applied to the side surface s1 for forming the recess groove 50 on the one side surface s1 and a direction of a load applied to the side surface s2 for forming the recess groove 50 on the other side surface s2 face each other. Accordingly, a part having a high stress concentrates on a region in the coil 15 that linearly connects the press portion 72a for forming the recess groove 50 on the one side surface s1 to the press portion 73a for forming the recess groove 50 on the other side surface s2, and the part having a high stress is less likely to spread to other parts.

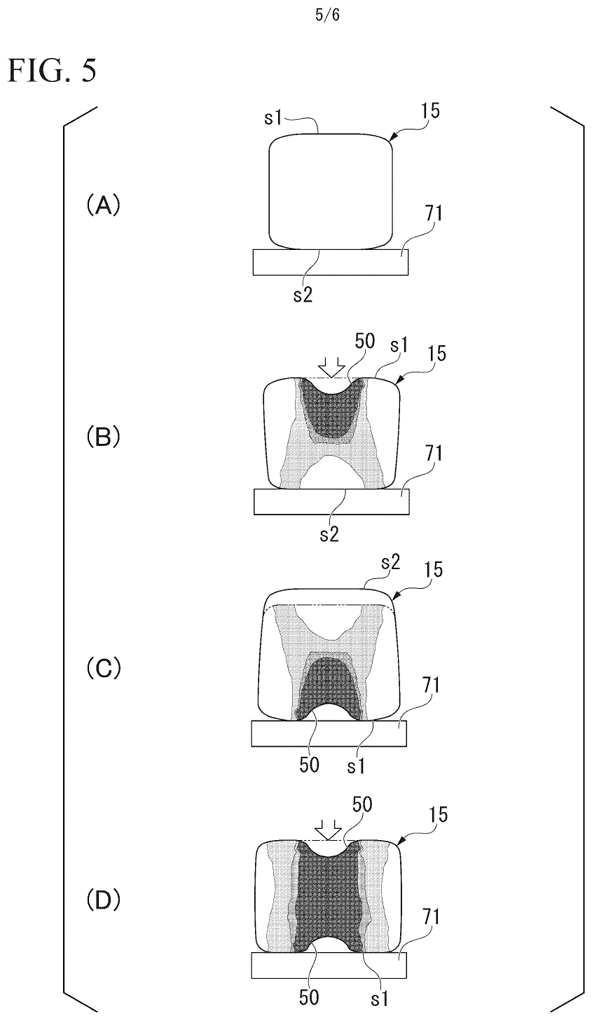

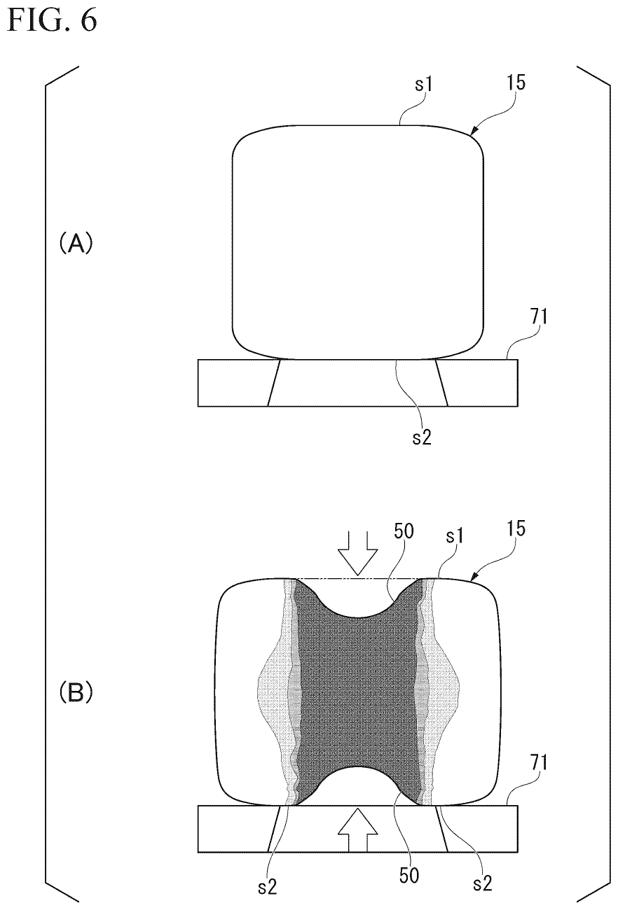

This is described in detail with reference to FIG. 5 and FIG. 6.

FIG. 5 is a view showing process steps (A), (B), (C), (D) when the press molding is performed on the side surfaces s1, s2 of the coil 15 that face in the opposite direction on one side at a time and a pressure distribution of an inner portion of the coil 15 at that time. FIG. 6 is a view showing process steps (A), (B) when the press molding is performed on both side surfaces s1, s2 of the coil 15 that face in the opposite direction in a temporally overlapping manner and a pressure distribution of an inner portion of the coil 15 at that time. In FIG. 5 and FIG. 6, a part having a large stress inside the coil 15 is represented by a darker density.

In a comparison example shown in FIG. 5, in the step (A), the coil 15 is placed on the placement base 71, and in the following step (B), the press molding is performed on one side surface s1 by a male mold from the upper side. Thereby, the recess groove 50 is formed on the one side surface s1. In the step (B), a press load acts between a press portion of the male mold that is pressed to a middle in the width direction of the side surface s1 of the coil 15 and a flat upper surface of the placement base 71. As a result, in the cross section of the coil 15, as indicated by a portion of a dark density in (B), a part having a large stress spreads outward in the width direction toward a lower side in a divergent manner. In (B), the part having a large stress is divided into two parts and spreads outward in the width direction of the coil 15.

In the following step (C), the coil 15 is turned upside down to cause the other side surface s2 to face upward, and one side surface s1 side is placed on the placement base 71. In this state, the stress that spreads in the width direction in a divergent manner toward the side surface s2 side remains in the cross section of the coil 15.

Then, in the step (D), the press molding is performed on the other side surface s2 by the male mold from the upper side. Thereby, the recess groove 50 is formed on the other side surface s2. In the step (D), a press load acts between a press portion of the male mold that is pressed to a middle in the width direction of the side surface s2 of the coil 15 and the flat upper surface of the placement base 71. As a result, in the cross section of the coil 15, as indicated by a portion of a dark density in (D), a part having a large stress spreads outward in the width direction toward a lower side in a divergent manner, and the stress is combined with the stress remaining in the coil 15. As a result, a part having a high stress remains in a wide region in the width direction of the coil 15. That is, a large stress acts on a region that is not directly related to the formation of the recess groove 50, and a strain occurs in an unnecessary part.

Further, in the processes (B), (D) of the press molding, since a large stress occurs in an unnecessary part of the coil 15, the load for pressing the male mold is correspondingly increased.

On the other hand, in the manufacturing method of the present embodiment shown in FIG. 6, in the step (A), the coil 15 is placed on the placement base 71, and in the following step (B), the press molding is performed by the male mold on the side surfaces s1, s2 from the upper side and the lower side, respectively. That is, the press molding on one side surface s1 and the press molding on another side surface s2 are temporally overlapped, and the press molding on the one side surface s1 and the press molding on the other side surface s2 are performed from a direction in which the side surfaces s1, s2 face each other. In the step (B), a press load acts between a middle region in the width direction of the one side surface s1 of the coil 15 and a middle region in the width direction of the other side surface s2. As a result, in the cross section of the coil 15, as indicated by a portion of a dark density in (B), a part having a large stress concentrates in a narrow region that connects the middle region in the width direction of the one side surface s1 to the middle region in the width direction of the other side surface s2 and does not spread outward in the width direction.

After the processing of the recess groove 50 is completed in this way, a strain is less likely to occur in an unnecessary part in the cross section of the coil 15.

A load that bends an end portion in the extension direction of the coil 15 toward a press direction acts on the vicinity of an end portion in the extension direction of the recess groove 50 on the side surfaces s1, s2 of the coil 15. Therefore, when the recess groove 50 is formed by press forming individually on the side surfaces s1, s2 of the coil 15 without temporally overlapping the press forming, a bend strain in a longitudinal direction easily remains at the end portion in the extension direction of the coil 15. However, in the manufacturing method of the coil 15 of the present embodiment, since the press molding is performed on the side surfaces s1, s2 that face in the opposite direction of the coil 15 substantially at the same time from the directions that face each other, the bend strain in the longitudinal direction hardly occurs at the end portion in the extension direction of the coil 15.

Accordingly, when the manufacturing method of the coil 15 of the present embodiment is employed, an unnecessary strain is less likely to occur in the coil 15 when the recess groove 50 is formed on the side surfaces s1, s2 of the coil 15 that face in the opposite direction. Therefore, when the manufacturing method of the coil 15 is employed, it is possible to further enhance a product quality of the coil 15, and it is possible to reduce an input load required for processing and realize smooth processing of the coil 15.

Further, in the manufacturing of the coil 15, at least one of start timings of the press molding to one side surface s1 and another side surface s2 and end timings of the press molding to the one side surface s1 and the other side surface s2 can be desirably matched with each other. When the start timings of the press molding to the one side surface s1 and the other side surface s2 are matched with each other, a deformation load that rapidly increases at an initial stage of the pressing is concentrated between the press portions 72a, 73a of both side surfaces s1, s2, and it is possible to prevent a part having a high stress from diffusing to the periphery. Further, when the end timings of the press molding to the one side surface s1 and the other side surface s2 are matched with each other, even if there is some variation in deformation in the one side surface s1 and the other side surface s2 prior to the end of the press molding, it is possible to finally correct the variation in the deformation.

Both of the start timings of the press molding to the one side surface s1 and the other side surface s2 and the end timings of the press molding to the one side surface s1 and the other side surface s2 can be further desirably matched with each other. In this case, the deformation load that rapidly increases at the initial stage of the pressing can be concentrated between the press portions of the one side surface s1 and the other side surface s2, and it is possible to finally correct the variation in the deformation of the one side surface s1 and the other side surface s2. Accordingly, when the present method is employed, it is possible to further enhance a processing accuracy of the recess groove 50 to the side surfaces s1, s2 of the coil 15.

Further, in the manufacturing method of the coil 15 of the present embodiment described above, when the press molding is performed to the one side surface s1 and the other side surface s2 of the coil 15, a pair of other remaining side surfaces s3, s4 are sandwiched by the support mold 74. In this case, by sandwiching the pair of other side surfaces s3, s4 by the support mold 74, it is possible to prevent the coil 15 from rotating at the time of the press molding. Accordingly, when the manufacturing method of the coil 15 of the present embodiment is employed, it is possible to perform the press molding to the coil 15 with high accuracy.

Further, in the manufacturing method of the coil 15 of the present embodiment, the support mold 74 is biased by the spring member 76 to be displaceable when a load is input. Therefore, when the present method is employed, it is possible to absorb an impact associated with an input of a large load at the time of the press molding by the function of the spring member 76.

Accordingly, when the present method is employed, it is possible to stably mold the recess groove 50 on the side surfaces s1, s2 that face in the opposite direction of the coil 15 with high accuracy.

The present invention is not limited to the embodiment described above, and various design changes can be made without departing from the scope of the invention. For example, in the embodiment described above, the recess groove 50 that is formed on the side surfaces s1, s2 of the coil 15 is formed to be recessed in an arc shape; however, the shape of the recess groove 50 is not limited to this shape. The recess groove 50 may have, for example, a shape in which a portion is a corner portion such as a triangular shape or a square shape, or the like.

Further, in the embodiment described above, the cross-sectional shape of the coil 15 (rotary electric machine coil) is a substantially rectangular shape; however, the cross-sectional shape of the coil 15 is not limited to the substantially rectangular shape. The cross-sectional shape of the coil 15 may be an even-numbered square shape other than a square shape such as a hexagon or an octagon as long as the cross-sectional shape has a first side surface and a second side surface that face in the opposite direction.

Further, in the embodiment described above, the coil 15 (rotary electric machine coil) having the recess groove 50 is used for the stator 10 part of the rotary electric machine 1; however, the coil 15 can be also applied to parts other than the stator 10. For example, in the rotary electric machine in which a coil winding portion is provided on the rotor part, the coil 15 can be also applied to the rotor part.

Further, in the embodiment described above, the first male mold 72 and the second male mold 73 are raised and lowered in an upward-downward direction, and thereby, the recess groove 50 is molded by the press molding on the side surfaces s1, s2 of the coil 15; however, the press direction of the first male mold 72 and the second male mold 73 is not limited to the upward-downward direction. The press direction of the first male mold 72 and the second male mold 73 may be, for example, a horizontal direction.

What is claimed is:

1. A rotary electric machine coil manufacturing method that is a manufacturing method of a rotary electric machine coil which has a first side surface and a second side surface that face in an opposite direction to each other and in which a recess groove along a longitudinal direction is provided on each of the first side surface and the second side surface, the rotary electric machine coil manufacturing method comprising:
when the recess groove is being formed by a press molding on one of the first side surface and the second side surface, starting a press molding of the recess groove to another of the first side surface and the second side surface.

2. The rotary electric machine coil manufacturing method according to claim 1,
wherein at least one of start timings of the press molding to the first side surface and the second side surface and end timings of the press molding to the first side surface and the second side surface are matched with each other.

3. The rotary electric machine coil manufacturing method according to claim 2,
wherein each of the start timings of the press molding to the first side surface and the second side surface and the end timings of the press molding to the first side surface and the second side surface are matched with each other.

4. The rotary electric machine coil manufacturing method according to claim 1,
wherein when the press molding is performed to the first side surface and the second side surface, a pair of other side surfaces that face in an opposite direction other than the first side surface and the second side surface are sandwiched by a support mold.

5. The rotary electric machine coil manufacturing method according to claim 4,
wherein the support mold is biased by a spring to be displaceable when a load is input.

6. The rotary electric machine coil manufacturing method according to claim 2,
wherein when the press molding is performed to the first side surface and the second side surface, a pair of other side surfaces that face in an opposite direction other than the first side surface and the second side surface are sandwiched by a support mold.

7. The rotary electric machine coil manufacturing method according to claim 6,
wherein the support mold is biased by a spring to be displaceable when a load is input.
